(19) United States
(12) Patent Application Publication
(10) Pub. No.: US 2015/0372629 A1
(43) Pub. Date: Dec. 24, 2015

(54) SYSTEM, METHOD AND APPARATUS OF SENSOR-LESS FIELD ORIENTED CONTROL FOR PERMANENT MAGNET MOTOR

(71) Applicant: SYSTEM GENERAL CORP., New Taipei City (TW)

(72) Inventors: Chih-Kai Huang, Hsinchu County (TW); Ta-Yung Yang, Milpitas, CA (US); Shih-Jen Yang, New Taipei City (TW)

(21) Appl. No.: 14/309,858

(22) Filed: Jun. 19, 2014

(51) Int. Cl. H02P 21/14; H02P 6/18; H02P 6/14; H02P 21/13

(52) U.S. Cl. CPC H02P 21/146; H02P 21/13; H02P 6/18; H02P 6/145

(57) ABSTRACT

A sensor-less control system, a method and an apparatus of sensor-less field oriented control for permanent magnet motors are provided. The sensor-less control system includes a Clarke transform module, a Park transform module and an angle estimation module. The Clarke transform module generates orthogonal current signals in accordance with motor phase currents. The Park transform module generates a current signal in response to the orthogonal current signals and an angle signal. The angle estimation module generates the angle signal in response to the current signal. The angle signal is related to a commutation angle of the permanent magnet motor. The current signal is controlled approximate to zero. The angle signal associated with an angle-shift signal is configured to generate three phase motor voltages.

### BACKGROUND OF THE INVENTION

1. Field of the Invention

The present invention relates to a field oriented control (FOC) technology for sensor-less permanent magnet (PM) motors, and more particularly relates to a sensor-less control system, a method and an apparatus of sensor-less field oriented control for permanent magnet motors (e.g., brushless permanent magnet synchronous motors (PMSM)).

2. Background of the Invention

A brushless permanent magnet synchronous motor (PMSM) is one kind of sensor-less PM motors, and is an electric motor driven by an AC electrical input. If the startup position of sensor-less permanent magnet motors can be detected, the motor can be started up without jerk.

The PMSM comprises a wound stator with stator windings, a permanent magnet rotor assembly and a sensing device to sense the rotor position of the PM rotor assembly. The sensing device generally includes a hall sensor, and the hall sensor provides signals for electronically switching the stator windings in a proper sequence to keep rotation of the PM rotor assembly. However, a hall sensor provided in the sensing device increases the cost of the PMSM and may cause malfunction to reduce the reliability of the PMSM. Therefore, a mechanism for the PM motor control without sensors is desired.

### SUMMARY OF THE INVENTION

The present invention provides a sensor-less control system for a permanent magnet motor. The sensor-less control system comprises a Clarke transform module, a Park transform module, and an angle estimation module. The Clarke transform module generates a plurality of orthogonal current signals in accordance with a plurality of motor phase currents. The Park transform module generates a current signal in response to the plurality of orthogonal current signals and an angle signal. The angle estimation module generates an angle signal in response to the current signal. The angle signal is related to a commutation angle of the permanent magnet motor. The current signal is controlled to approximate to zero. The angle signal associated with an angle-shift signal is configured to generate three phase motor voltages.

From another point of view, the present invention further provides an apparatus of sensor-less field oriented control for a permanent magnet motor. The apparatus comprises a Clarke transform module, a Park transform module, an angle estimation module, and sum module. The Clarke transform module generates a plurality of orthogonal current signals in accordance with a plurality of motor phase currents. The Park transform module generates a current signal in response to the plurality of orthogonal current signals and a first angle signal. The angle estimation module generates the first angle signal in response to the current signal. The sum module generates a second angle signal according to the first angle signal and an angle-shift signal. The current signal is controlled approximate to zero. The second angle signal is configured to generate three phase motor voltages.

From the other point of view, the present invention further provides a method of sensor-less field oriented control for permanent magnet motor. The method comprises the following steps. A plurality of orthogonal current signals is generated in accordance with a plurality of motor phase currents. A current signal is generated in response to the plurality of orthogonal current signals and an angle signal. The angle signal is generated in response to the current signal. The angle signal is related to a commutation angle of the permanent magnet motor; the current signal is controlled approximate to zero; and, the angle signal is configured to generate three phase motor voltages.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 shows a block diagram illustrating a sensor-less control system of FOC for the PM motor.

FIG. 2 shows schematic views illustrating an algorithm of the sliding mode observer.

FIG. 3 shows a block diagram illustrating the sliding mode observer.

FIG. 4 shows a schematic view illustrating an equivalent model of the PMSM.

FIG. 5 shows a block diagram illustrating a sensor-less control system of FOC for the PM motor according to one embodiment of the present invention.

FIG. 6 shows a block diagram illustrating the angle estimation module according to one embodiment of the present invention.

FIG. 7 shows a block diagram illustrating the proportional integral (PI) controller according to one embodiment of the present invention.

FIG. 8 shows a block diagram illustrating the angle estimation module according to another embodiment of the present invention.

FIG. 9 shows a block diagram illustrating a sensor-less control system of FOC according to another embodiment of the present invention.

FIG. 10 shows the waveforms generated by the sine-wave generator in FIG. 9 according to another embodiment of the present invention.

FIG. 11 shows a flowchart illustrating a method of sensor-less field oriented control for permanent magnet motor according to one embodiment of the present invention.

### DETAILED DESCRIPTION OF EMBODIMENTS

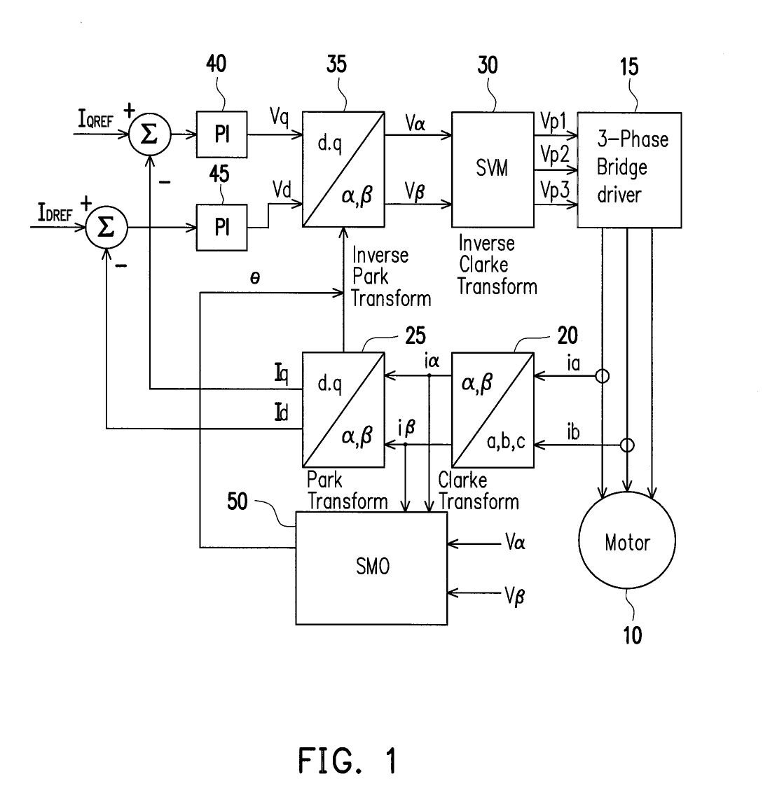

A PM motor, compared to old-fashioned motors, usually exhibits advantages of high efficiency, small dimension, fast dynamic response and low noise. Because the speed of the rotor magnetic field of the PM motor must be equal to the speed of the stator magnetic field, one of the rotor flux, the stator flux and air-gap flux in the field oriented control is considered as a basis to create a reference frame for the other flux to decouple a torque component and a flux component in the current of the stator. The armature current is responsible for the torque generation, and the excitation current is responsible for the flux generation. Generally, the rotor flux is considered as a reference frame for the stator flux and air-gap flux. The sensor-less control system and the apparatus of FOC for the PM motor is exemplarily illustrated in FIG. 1. FIG. 1 shows a block diagram illustrating a sensor-less control system of FOC for the PM motor. The sensor-less control system comprises a permanent magnet synchronous motor (PMSM) 10, a three-phase bridge driver 15, and a space vector modulation (SVM) module 30. A Clarke transform module 20 is generally configured to transform a three-axis, two-dimensional coordinate system (referenced to the stator) to a two-axis coordinate system. The Clarke transformation is also known as the alpha-beta transformation in electrical engineering. The phase currents of a motor 10 presented by vectors can be expressed as the following formulas (1)-(3).

\vec{ia}+\vec{ib}+\vec{ic}=0 (1)

\vec{iα}=\vec{iβ} (2)

\vec{iβ}=(\vec{ia}+2×\vec{ib})÷\sqrt{3} (3)

wherein ia, ib and ic are phase currents of the motor 10 presented by vectors. The iα and iβ are two-axis orthogonal currents mapping the motor's phase currents of ia, ib and ic.

A Park transform module 25 is configured to transform iα, iβ and the angle signal θ to another two-axis system that is corresponding to the rotor flux. This two-axis rotating coordinate system is called a “d-q axis”. The Park transform module 25 generates signals Id and Iq according to the two-axis orthogonal currents iα and iβ. In electrical engineering, the Park transformation is also known as direct-quadrature-zero (or dq0) transformation or zero-direct-quadrature (or 0dq) transformation. The parameter θ represents the rotor angle of the phase currents of the motor 10. The signals Id and Iq generated by the Park transform module 25 can be expressed as the following formulas (4)-(5).

Id=\vec{iα}×cosθ+\vec{iβ}×sinθ (4)

Iq=(−\vec{iα})×sinθ+\vec{iβ}×cosθ (5)

An inverse Park transform module 35 is utilized to transform a two-axis rotating d-q frame (i.e., signals Vd and Vq) to a two-axis stationary frame α-β (i.e., signals Vα and Vβ). The signals Vd and Vq are generated by the controllers 40 and 45. The signals Vα and Vβ can be expressed as the following formulas (6)-(7).

Vα=Vd×cosθ+Vq×sinθ (6)

Vβ=Vd×sinθ+Vq×cosθ (7)

An inverse Clarke transform module 30 is utilized to transform a stationary two-axis frame α-β (i.e., voltages Vα and vβ) to a stationary three-axis (three-phase reference frame of the stator) (i.e., three-phase motor voltage signals Vp1, Vp2 and Vp3). The three-phase motor voltage signals Vp1, Vp2 and Vp3 generated by the inverse Clarke transform module 30 can be expressed as the following formulas (8)-(10)

Vp1=Vβ (8)

Vp2=(−Vβ+\sqrt{3}×Vα)÷2 (9)

Vp3=(−Vβ−\sqrt{3}×Vα)÷2 (10)

This three-phase motor voltage signals (Vp1, Vp2, Vp3) are applied to generate pulse width modulation signals through space vector modulation (SVM) techniques.

The controllers 40 and 45 are proportional integral (PI) controllers responding to an error signal in a closed control loop. The closed control loop is configured to adjust the controlled quantity to achieve the desired system response. The controlling parameters could be speed, torque or flux representing measurable quantities. The error signal is obtained by subtracting desired parameters (i.e., I_{QREF} and I_{DREF}) for control by the actual measurement values of that parameter. The positive and negative signs of the error signals indicate the direction required by the control input.

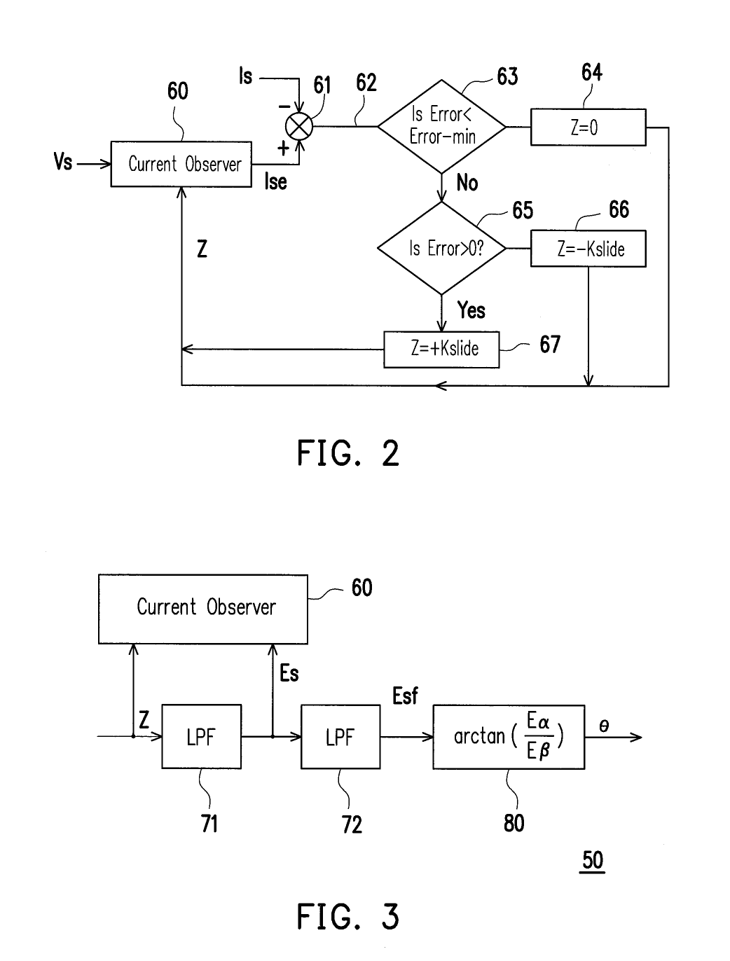

A sliding mode observer (SMO) 50 is configured for the generation of the angle signal θ and the estimation of the motor's speed. FIG. 2 shows schematic views illustrating an algorithm of the sliding mode observer 50. The parameter Vs represents an input voltage applied to the motor 10 in FIG. 1, the parameter Is represents a phase current of the motor 10, and the parameter Ise represents an estimated phase current of the motor 10. A current observer 60 receives input voltage Vs and outputs estimated phase current Ise representing an estimated phase current, and the estimated phase current Ise is combined with the phase current Is through a mixer 61 to generate an error signal 62. The error signal 62 is input into steps of determination. A determination step 63 determines if the error signal 62 is smaller than a built-in value Error-min. If the error signal 62 is smaller than the built-in value Error-min, then an output correction factor voltage Z is set to zero in step 64. If the error signal 62 is not smaller than the built-in value Error-min, then the algorithm goes to a determination step 65 to determine if the error signal 62 is larger than zero. If the error signal 62 is not larger than zero, the output correction factor voltage Z equals to a negative parameter −Kslide in step 66. If the error signal 62 is larger than zero, the output correction factor voltage Z equals to a positive parameter +Kslide in step 67.

Z is the output correction factor voltage. The algorithm is emphasized in calculation of the commutation angle signal θ required by the FOC scheme. The position and estimation of the motor 10 in FIG. 1 are calculated according to measured currents and calculated voltages.

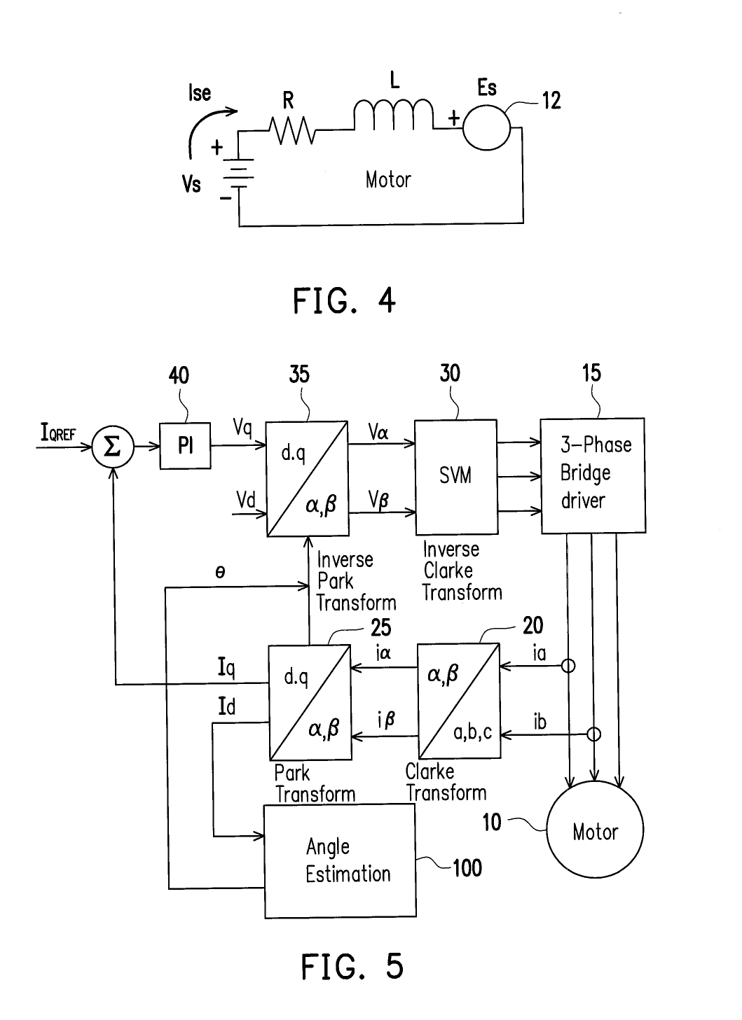

FIG. 3 shows a block diagram illustrating the sliding mode observer 50. The sliding mode observer 50 comprises a current observer 60, low pass filter (LPF) 71 and 72, and an arctangent calculation block 80. FIG. 4 shows a schematic view illustrating an equivalent model of the PMSM. The equivalent model 500 of the PMSM comprises a motor voltage voltage Vs that applied to the PMSM, a winding resistance R, a winding inductance L and an electromotive force source (EMF) Es 12. The following description should be combined with FIG. 3 and FIG. 4. The relationships among Ise, L, R, t Vs, and Es can be expressed as the formulas (11).

$$\frac{d ( Ise )}{d t} = \frac{R}{L} \times Ise + \frac{1}{L} \times ( Vs - Es - Z ) \qquad ( 11 )$$

where Ise is an estimated phase current; Vs is the input voltage of the PMSM; Es is the back-EMF; Z is the output correction factor voltage.

Two motor conditions should be considered. In the first condition, the same input Vs was fed into both system, and in the second condition, the measured current Is should be matched with the estimated current Ise from the model. Therefore, we presume that the back-EMF Es of the model is the same as the back-EMF Es of the motor. When the value of the error signal is less than Error-min, the current observer 60 operates in a linear range. For an error signal outside of the linear range, the output of the current observer 60 is (+Kslide)/(−Kslide) depending on the sign of the error signal. The current observer 60 is utilized to compensate the motor model in FIG. 4, and estimate the back-EMF Es by filtering the correction factor Z through a low pass filter 71. The estimated back-EMF Es is further configured to generate values of Eα and Eβ (vector components of Es) through the filer 72 for the estimated angle signal θ (via the arctangent calculation block 80). The parameter Esf is generated by the LPF 72 according to the estimated back-EMF Es. The estimated angle signal θ can be expressed as the formulas (12).

$$θ = arctan ( \frac{E α}{E β} ) \qquad ( 12 )$$

Because the sliding mode observer (SMO) 50 in FIG. 1 requires accurate motor's parameters and complex calculations for the estimation of the commutation angle signal θ, thus a high-speed and expensive digital signal processor (DSP) is required for this operation. The present invention provides a simple approach that allows implementing the sensor-less control system of FOC and achieving high performance by a lower cost microcontroller.

FIG. 5 shows a block diagram illustrating a sensor-less control system of FOC for the PM motor according to one embodiment of the present invention. The sensor-less control system comprises the permanent magnet synchronous motor (PMSM) 10, the three-phase bridge driver 15, the space vector modulation (SVM) module 30 for the inverse Clarke transformation, the Clarke transform module 20, the Park transform module 25, the inverse Park transform module 35, the proportional integral (PI) controller 40 and an angle estimation module 100. The Park transform module 25 generates signals Id and Iq. The angle estimation module 100 simply generates the commutation angle signal θ in accordance with the signal Id. The commutation angle signal θ is further coupled to the Park transform module 25 and the inverse Park transform module 35 to generate the pulse-width modulation signals Iq and Id, Vα and Vβ for 3-phase motor voltage signals. Descriptions of other blocks can be referenced to the descriptions of FIG. 1.

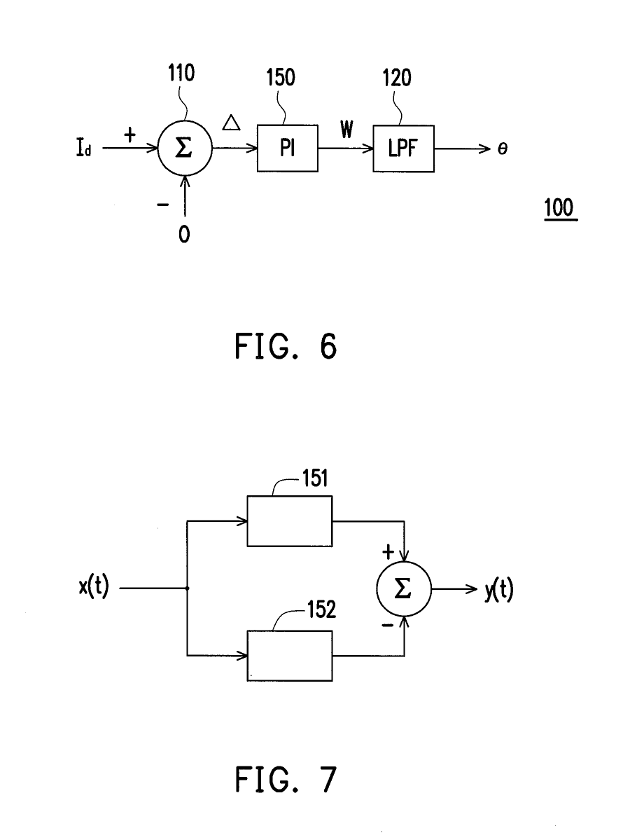

FIG. 6 shows a block diagram illustrating the angle estimation module 100 according to one embodiment of the present invention. The angle estimation module 100 comprises an sum module 110, a proportional integral (PI) controller 150, and a LPF 120. The sum module 110 adds the signal Id and a zero signal O to generate the input signal of the PI controller 150. The PI controller 150 is coupled to receive the signal Id for generating a speed signal ω. The speed signal co is derived by controlling the signal Id approximate equals to zero. The filter 120 is utilized to generate the commutation angle signal θ in accordance with the speed signal ω.

FIG. 7 shows a block diagram illustrating the proportional integral (PI) controller 150 according to one embodiment of the present invention. The proportional term of the PI controller 150 is formed by multiplying the input signal (i.e., an error signal X(t)) with a first gain (i.e., gain KP) in block 151, and the PI controller 150 is configured to produce a control response that is a function of the error magnitude. The integral term of the PI controller 150 is utilized to eliminate small steady state errors. The integral term of the PI controller 150 calculates a continuous total of the error signal. This accumulated steady state error signal is multiplied by a second gain (i.e., gain KI) in block 152. The relationships among error signal x(t), y(t), gains KP and KI can be expressed as the formulas (13):

y(t)=Kₚ×x(t)−ᵢ∫x(t)dt (13)

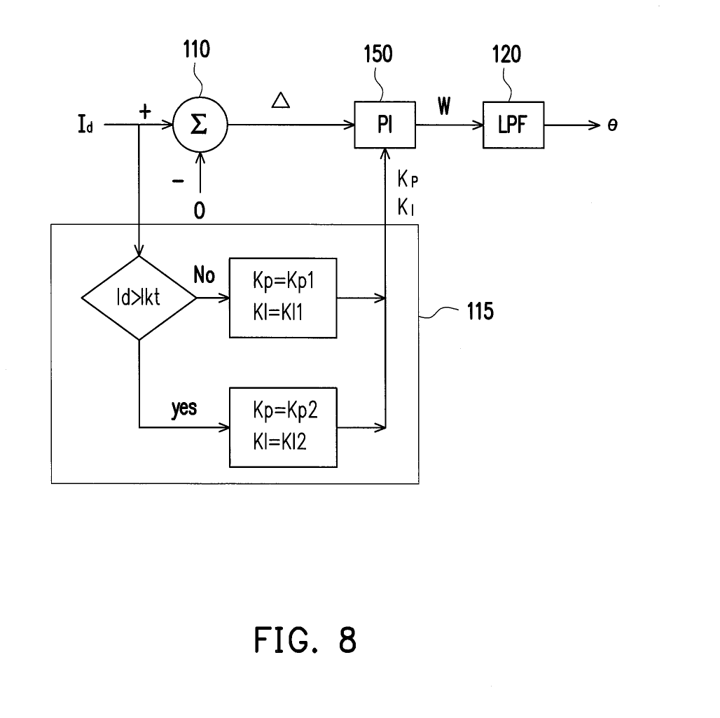

FIG. 8 shows a block diagram illustrating the angle estimation module 100 according to another embodiment of the present invention. The angle estimation module 100 comprises a proportional integral (PI) controller 150. The PI controller 150 is configured to receive the signal Id for generating a speed signal ω. The speed signal co is derived by controlling the Id signal approximate equals to zero. A filter 120 is utilized to generate the commutation angle signal θ in accordance with the speed signal co. The proportional integral (PI) controller 150 comprises two parameters, such as a first gain KP and a second gain KI, for the PI control. To ensure that the signal Id is operated in the linear region of the loop, the block 115 determines if the value of the signal Id is larger than a threshold value Ikt. If the value of the signal Id is smaller than the threshold value Ikt, then the first gain KP and the second gain KI are set to original settings KP1 and KI1. If the value of the signal Id is larger than the threshold Ikt, then the first gain KP and the second gain KI will be set to KP2 and KI2 respectively for different loop response and operation.

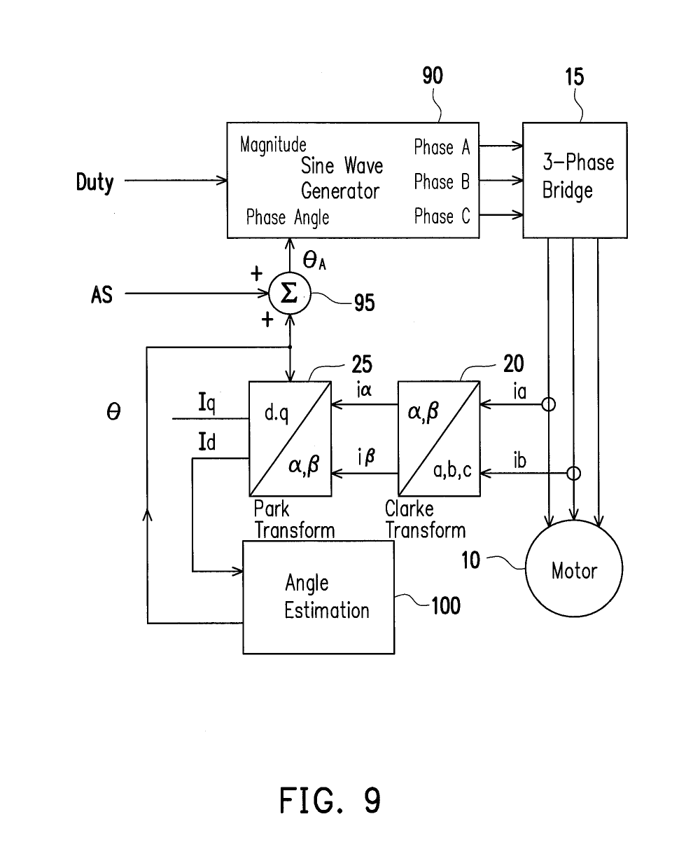

FIG. 9 shows a block diagram illustrating a sensor-less control system of FOC according to another embodiment of the present invention. The sensor-less control system of FOC comprises the permanent magnet synchronous motor (PMSM) 10, the three-phase bridge driver 15, the Clarke transform module 20, the Park transform module 25, a sine-wave signal generator 90 and the angle estimation module 100. The Park transform module 25 generates the signal Id by receiving signals iα and iβ. The angle estimation module 100 generates the angle signal θ according to the signal Id. The angle signal θ further feedbacks to the Park transform module 25. A sum unit 95 generates another angle signal θ_{A} according to the angle signal θ and an angle-shift signal AS. The angle-shift signal AS is used for adapting to various PM motors, and/or for the weak magnet control.

The angle signal θ_{A} and a duty signal Duty are coupled to the sine-wave generator 90 to generate the pulse-width modulation signals for 3-phase motor voltage signals (phase A, phase B and phase C). The sine-wave generator 90 has two inputs including a magnitude input and a phase angle input. The magnitude input is coupled to the duty signal Duty. The phase angle input is coupled to the angle signal θ_{A}.

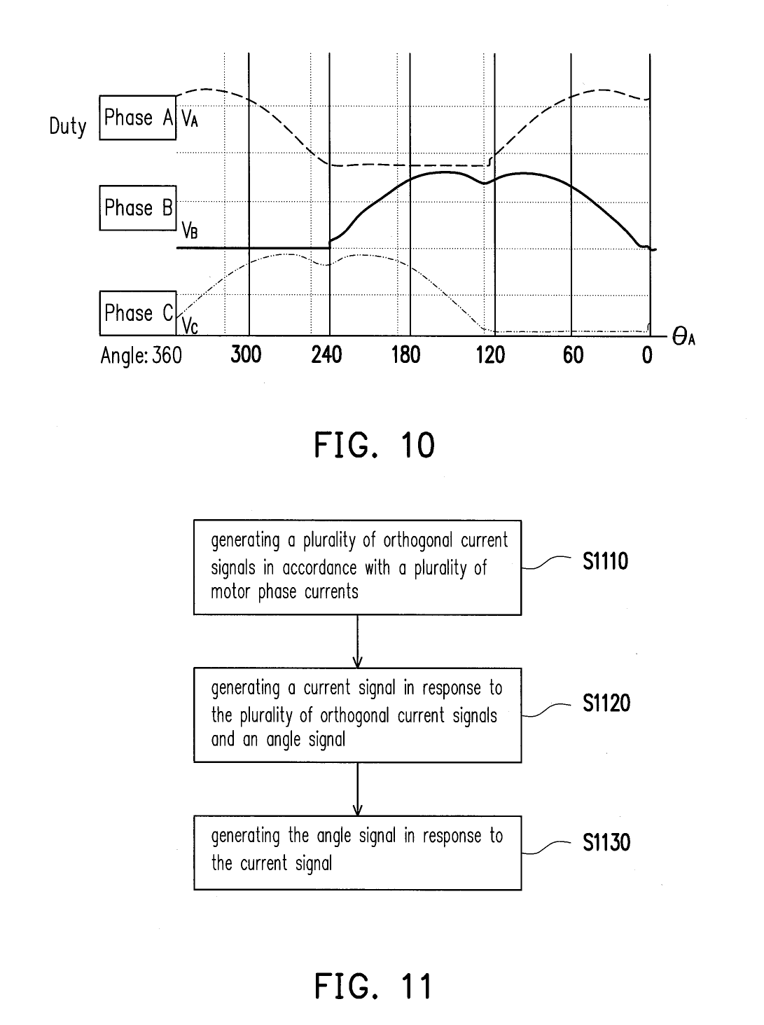

FIG. 10 shows the waveforms generated by the sine-wave generator 90 in FIG 9 according to another embodiment of the present invention. The amplitude of 3-phase motor voltage signals V_{A}, V_{B}, and V_{C} is programmed by the duty signal Duty. The angle of 3-phase motor voltage signals V_{A}, V_{B}, and V_{C} is determined by the angle signal θ_{A}.

FIG. 11 shows a flowchart illustrating a method of sensor-less field oriented control for permanent magnet motor according to one embodiment of the present invention. In the present embodiment, the method of sensor-less field oriented control is applicable to the apparatus of FIG. 5. In step S1110, the Clarke transform module 20 generates a plurality of orthogonal current signals (i.e., signals iα and iβ) in accordance with a plurality of motor phase currents (i.e., currents ia, ib and ic). In step S1120, the Park transform module 25 generates a current signal Id in response to the plurality of orthogonal current signals (i.e., signals iα and iβ) and an angle signal θ. In step S1130, the angle estimation module 100 generates the angle signal θ in response to the current signal Id. The angle signal θ is related to a commutation angle of the permanent magnet motor 10. The current signal Id is controlled approximate to zero. The angle signal θ associated with an angle-shift signal AS is configured to generate three phase motor voltages (i.e., phase A, phase B and phase C). The techniques combined with detailed actuation of electronic components are already described in the above embodiments of the present invention.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A sensor-less control system for a permanent magnet motor, comprising:
a Clarke transform module generating a plurality of orthogonal current signals in accordance with a plurality of motor phase currents;
a Park transform module generating a current signal in response to the plurality of orthogonal current signals and an angle signal; and
an angle estimation module generating the angle signal in response to the current signal;
wherein the angle signal is related to a commutation angle of the permanent magnet motor; the current signal is controlled approximate to zero; the angle signal associated with an angle-shift signal is configured to generate three phase motor voltages.

2. The system as claimed in claim 1, further comprising:
a space vector modulation module for generating the three phase motor voltages in response to the angle signal.

3. The system as claimed in claim 1, in which the angle estimation module comprising:
a proportional integral controller for generating a speed signal; and
a filter generating the angle signal in accordance with the speed signal,
wherein the speed signal is generated by controlling the current signal approximate to zero.

4. The system as claimed in claim 3, in which the proportional integral controller, comprising:
a first gain parameter; and
a second gain parameter,
wherein the first gain parameter and second gain parameter are programmable in response to the current signal.

5. An apparatus of sensor-less field oriented control for a permanent magnet motor, comprising:
a Clarke transform module generating a plurality of orthogonal current signals in accordance with a plurality of motor phase currents;
a Park transform module generating a current signal in response to the plurality of orthogonal current signals and a first angle signal;
an angle estimation module generating the first angle signal in response to the current signal; and
a sum module generating a second angle signal according to the first angle signal and an angle-shift signal,
wherein the current signal is controlled approximate to zero; the second angle signal is configured to generate three phase motor voltages.

6. The apparatus as claimed in claim 5, further comprising:
a sine-wave generator for generating the three phase motor voltages in response to the second angle signal.

7. The apparatus as claimed in claim 5, in which the angle estimation module comprising:
a proportional integral controller for generating a speed signal; and
a filer generating the angle signal in accordance with the speed signal,
wherein the speed signal is generated by controlling the current signal approximate to zero; the proportional integral controller comprising a first gain parameter and a second gain parameter; the first gain parameter and second gain parameter are programmable in response to the current signal.

8. A method of sensor-less field oriented control for permanent magnet motor, comprising:
generating a plurality of orthogonal current signals in accordance with a plurality of motor phase currents;
generating a current signal in response to the plurality of orthogonal current signals and an angle signal;
generating the angle signal in response to the current signal;
wherein the angle signal is related to a commutation angle of the permanent magnet motor; the current signal is controlled approximate to zero; the angle signal is configured to generate three phase motor voltages.

9. The method and apparatus as claimed in claim 8, further comprising:
generating the three phase motor voltages in response to the angle signal and an error magnitude signal.

10. The method as claimed in claim 8, in which the step of generating the angle signal comprising following steps:
generating a speed signal by a proportional integral controller; and
generating the angle signal in accordance with the speed signal through a filtering,
wherein the speed signal is generated by controlling the current signal approximate to zero.

11. The method as claimed in claim 8, in which the three phase motor voltages is generated by a sine-wave generator.

12. The method as claimed in claim 10, wherein the proportional integral controller comprising a first gain parameter and a second gain parameter; the first gain parameter and the second gain parameter are programmable in response to the current signal.
